(19) United States
(12) Patent Application Publication
(10) Pub. No.: US 2011/0141282 A1
(43) Pub. Date: Jun. 16, 2011

(54) INTERSECTION SITUATION RECOGNITION SYSTEM

(75) Inventors: Takuma NOTSU, Osaka (JP); Masahiro Ogawa, Osaka (JP); Kenji Takahashi, Shiga (JP)

(73) Assignee: PANASONIC CORPORATION, Osaka (JP)

(21) Appl. No.: 13/032,306

(22) Filed: Feb. 22, 2011

Related U.S. Application Data
(63) Continuation of application No. PCT/JP2009/002145, filed on May 15, 2009.

(30) Foreign Application Priority Data
Aug. 26, 2008 (JP) 2008-216499

(51) Int. Cl. H04N 7/18

(52) U.S. Cl. 348/149; 348/E07.085

(57) ABSTRACT

An image pickup device that picks up an image of a direction not visible from a vehicle that is about to enter an intersection, and transmits the picked-up image to the vehicle is installed in the vicinity of a blind intersection. In addition, an in-vehicle device that receives the image from the image pickup device, and displays the image on a display device is mounted in the vehicle. The in-vehicle device retrieves an image pickup device identification number of an image pickup device installed at the intersection that the vehicle is about to enter and transmits the retrieved image pickup device identification number to the image pickup device and, only when an image pickup device identification number received from the image pickup device together with an intersection image and the retrieved image pickup device identification number match with each other, the in-vehicle device displays the received intersection image.

This application is a continuation of International Patent Application No. PCT/JP2009/002145, filed May 15, 2009, the disclosure of which is incorporated herein by reference in its entirety. International Patent Application No. PCT/JP2009/002145 is entitled to the benefit of Japanese Patent Application No. 2008-216499, file on Aug. 26, 2008, the disclosure of which is incorporated herein by reference in its entirety.

### TECHNICAL FIELD

The present invention relates to an intersection situation recognition system for supporting safety confirmation during driving of a vehicle, and in particular relates to an intersection situation recognition system as a safety system capable of recognizing a situation of movement of vehicles, pedestrians and the like at a blind intersection or on a road positioned in a blind spot by a curve.

### BACKGROUND ART

In general, at a blind curve and an intersection such as a T-shaped intersection or a crossroad, there is installed a safety device for supporting the securement of visibility such as a convex mirror or the like in order to allow vehicles such a bicycle, a motorcycle, and an automobile to safely pass therethrough.

In addition, there is developed a safety confirmation device in which a camera is incorporated in a front bumper of an automobile, an image of a road in a blind spot is picked up by using the camera, and the picked-up image is displayed on an in-vehicle monitor for car navigation or the like. According to this device, even when it is not possible to grasp the situation of a road that remains in a blind spot unless the automobile enters to some extent such as an intersection, only if the front bumper of the automobile is caused to enter the intersection, the road in the blind spot can be viewed in advance.

Further, there is devised a system in which, instead of incorporating the camera in the automobile, a camera is installed at an intersection, an image of a road positioned in a blind spot from the automobile is picked up, and the picked-up image is transmitted by wireless communication to the automobile that is about to pass through the intersection. With this system, it becomes possible to avoid a crash between automobiles at an intersection and a physical injury resulting from sudden running into the intersection of a child or the like.

### SUMMARY OF INVENTION

### Technical Problem

However, in the case of the safety device such as the convex mirror or the like, there have occurred problems such as that the safe device is installed at a position that is difficult to see from a running automobile, that the safety device is difficult to see due to a problem with its installation angle, and that the road situation can not be recognized because of the reflection of light such as sunlight or the like.

In addition, in the case of the safety confirmation device with the camera incorporated in the front bumper of the automobile, although the road situation is easily grasped because the safety confirmation requires only viewing of the in-vehicle monitor, there has occurred a problem that at least the front bumper needs to enter the intersection so that it is not possible to completely avoid the crash and the like.

In Japanese Unexamined Patent Publication No. 2001-101566, since the automobile receives the image from the camera installed at the intersection, it is possible to grasp the road situation without causing the automobile to enter the intersection. However, since a method for determining, among innumerable intersections, from which intersection the automobile is receiving the image picked up by the camera is not described, there is a possibility that the automobile is receiving an image of a road other than a road at the intersection that the automobile is about to enter.

Despite the situation in which another automobile or a pedestrian is about to enter the intersection that the automobile is about to enter from a direction in a blind spot, when the received image is an image of another intersection, and no vehicle or pedestrian is seen in the image, a driver considers that the intersection is safe and drives the automobile into the intersection. In this case, it is extremely highly possible that a traffic accident occurs, which is extremely dangerous.

The present invention has been achieved in view of the above-described circumstances, and an object thereof is to provide an intersection situation recognition system capable of reliably grasping a situation of a road in a blind spot when vehicles such as an automobile and the like pass through an intersection.

### Solution to Problem

In order to solve the above-described problem, an intersection situation recognition system of the present invention includes an image pickup device installed in a vicinity of an intersection, and for picking up an image of a direction not visible from a vehicle that is about to enter the intersection and transmitting the picked-up image to the vehicle that is about to enter the intersection, and an in-vehicle device mounted in the vehicle that is about to enter the intersection, and for receiving and displaying the image from the image pickup device installed in the vicinity of the intersection.

The in-vehicle device has a vehicle position detection unit for detecting a position of the vehicle in which the in-vehicle device is mounted and a running direction thereof, an image pickup device retrieval unit for determining the intersection that the vehicle is about to enter from the position of the vehicle and the running direction thereof detected by the vehicle position detection unit, and retrieving an image pickup device identification number in correspondence to the image pickup device installed in the vicinity of the determined intersection, an in-vehicle device-side transmission unit for transmitting the image pickup device identification number retrieved by the image pickup device retrieval unit to the image pickup device installed in the vicinity of the intersection, an in-vehicle device-side reception unit for receiving the image and an image pickup device identification number transmitted from the image pickup device installed in the vicinity of the intersection, an in-vehicle device-side identification number comparison unit for comparing the image pickup device identification number received by the in-vehicle device-side reception unit with the image pickup device identification number retrieved by the image pickup device retrieval unit, and detecting a match between the image pickup device identification numbers, and a display device for displaying the image received from the image pickup device in correspondence to the image pickup device identification numbers between which the match is detected by the in-vehicle device-side identification number comparison unit.

In addition, the image pickup device has an image pickup device identification number setting unit for setting the unique image pickup device identification number, an image pickup unit for picking up an image of an intersection situation, an image pickup device-side reception unit for receiving the image pickup device identification number transmitted from the in-vehicle device mounted in the vehicle that is about to enter the intersection, an image pickup device-side identification number comparison unit for comparing the image pickup device identification number received by the image pickup device-side reception unit with the unique image pickup device identification number set in the image pickup device, and detecting a match between the image pickup device identification numbers, a transmission judgment unit for judging whether or not transmission is permitted in accordance with a result of the match detection by the image pickup device-side identification number comparison unit, and an image pickup device-side transmission unit for transmitting the image picked up by the image pickup unit and the unique image pickup device identification number to the in-vehicle device mounted in the vehicle that is about to enter the intersection when the image pickup device identification numbers match with each other and the transmission judgment unit judges that the transmission is permitted.

According to the configuration, since the situation of a road in a blind spot can be grasped before the vehicle enters the intersection, it is possible to significantly reduce the possibility of occurrence of a crash or a physical injury. In addition, since the image pickup device is assigned with the image pickup device identification number, it is possible to identify the image pickup device installed at the intersection that the vehicle is about to enter without misrecognition. Consequently, the situation of the road in the blind spot can be reliably grasped.

In the intersection situation recognition system having the above-described configuration, the image pickup device retrieval unit preferably pre-records positional information, an image pickup direction, and the image pickup device identification number of the image pickup device in association with each other.

According to the configuration, it is not necessary to constantly transmit the positional information, the image pickup direction, and the image pickup device identification number of the image pickup device from the image pickup device to a surrounding area to inform the in-vehicle device mounted in the vehicle running in the surrounding area of them, and it is possible to retrieve the identification number of the image pickup device installed at the intersection that the vehicle is about to enter only on the in-vehicle device side.

In addition, in the intersection situation recognition system having the above-described configuration, the image pickup device preferably has a transmission unit for transmitting image pickup device installation information including positional information, an image pickup direction, and the image pickup device identification number of the image pickup device to a surrounding area, and the in-vehicle device preferably has an image pickup device installation information reception unit for receiving the image pickup device installation information including the positional information, the image pickup direction, and the image pickup device identification information of the image pickup device.

According to the configuration, even when a new image pickup device is additionally installed at the intersection, the in-vehicle device can automatically obtain the image pickup device installation information including the positional information, the image pickup direction, and the image pickup device identification number of the image pickup device only by the running of the vehicle in which the in-vehicle device is mounted in the vicinity of the intersection. As a result, it is not necessary to perform additional work such as periodically asking an in-vehicle device manufacturer or a dealer to update the image pickup device installation information in the image pickup device retrieval unit of the in-vehicle device, or downloading the image pickup device information on the Internet to update the image pickup device retrieval unit using the data.

Further, in the intersection situation recognition system having the above-described configuration, the image pickup device retrieval unit preferably records the positional information, the image pickup direction, and the image pickup device identification number of the image pickup device received by the image pickup device installation information reception unit in association with each other.

According to the configuration, since it is possible to record the positional information, the image pickup direction, and the image pickup device identification number of the image pickup device as a database once the vehicle runs through the intersection, it is possible to quickly retrieve the image pickup device installed at the intersection when the vehicle enters the intersection.

Moreover, in the intersection situation recognition system having the above-described configuration, the in-vehicle device preferably has a priority judgment unit for assigning priorities to a plurality of image pickup devices based on an image pickup direction of the plurality of image pickup devices and the running direction of the vehicle in which the in-vehicle device is mounted in a state where the plurality of image pickup devices are installed at the intersection that the vehicle is about to enter, the in-vehicle device-side transmission unit preferably transmits the priorities of the plurality of image pickup devices assigned by the priority judgment unit in association with the image pickup device identification number, the image pickup device-side reception unit preferably receives the priorities of the image pickup devices from the in-vehicle device mounted in the vehicle that is about to enter the intersection, and the image pickup device preferably further has an image quality determination unit for determining an image quality of the image to be transmitted to the in-vehicle device mounted in the vehicle that is about to enter the intersection in accordance with the priorities of the image pickup devices received by the image pickup device-side reception unit, and an image processing unit for performing image processing on the image picked up by the image pickup unit in accordance with the image quality determined in the image quality determination unit.

According to the configuration, since the image of the image pickup direction having high priority is displayed with high image quality and the image having low priority is displayed with low image quality, it becomes possible to recognize the situation of the intersection with increased accuracy, and the safety when the vehicle passes through the intersection can be enhanced.

Furthermore, in the intersection situation recognition system having the above-described configuration, the priority judgment unit preferably assigns the priorities in accordance with route guidance of a route guidance device mounted in the vehicle in which the in-vehicle device is mounted.

In addition, in the intersection situation recognition system having the above-described configuration, the priority judgment unit preferably assigns the priorities in accordance with a direction of a direction indicator of the vehicle in which the in-vehicle device is mounted.

Further, in the intersection situation recognition system having the above-described configuration, the in-vehicle device preferably has an in-vehicle device identification number setting unit for setting a unique in-vehicle device identification number, the in-vehicle device-side transmission unit preferably transmits the unique in-vehicle device identification number to the image pickup device installed in the vicinity of the intersection, the image pickup device-side reception unit preferably receives the in-vehicle device identification number transmitted from the in-vehicle device mounted in the vehicle that is about to enter the intersection, the image pickup device-side transmission unit preferably transmits the in-vehicle device identification number to the in-vehicle device mounted in the vehicle that is about to enter the intersection, the in-vehicle device-side reception unit preferably receives the in-vehicle device identification number transmitted from the image pickup device installed in the vicinity of the intersection, the in-vehicle device-side identification number comparison unit preferably compares the in-vehicle device identification number received by the in-vehicle device-side reception unit with the in-vehicle device identification number unique to the in-vehicle device, and detects a match between the in-vehicle device identification numbers, and the display device preferably displays the image received from the image pickup device in correspondence to the image pickup device identification numbers between which the match is detected by the in-vehicle device-side identification number comparison unit when the match between the in-vehicle device identification number received by the in-vehicle device-side reception unit and the in-vehicle device identification number unique to the in-vehicle device is detected by the in-vehicle device-side identification number comparison unit.

According to the configuration, it is possible to avoid the displaying of the image transmitted to the in-vehicle device mounted in another vehicle running in the same intersection by mistake.

Moreover, in the intersection situation recognition system having the above-described configuration, the display device preferably displays the received image on an entire screen.

According to the configuration, since the image of the intersection can be displayed largely, the situation of the intersection is easily recognized.

Furthermore, in the intersection situation recognition system having the above-described configuration, the display device preferably divides a screen, and displays the received image on a part of the screen and displays another image on a remaining portion of the screen simultaneously with the received image.

According to the configuration, the display device can be effectively used for other purposes.

In addition, in the intersection situation recognition system having the above-described configuration, the another image is preferably an image showing route guidance.

According to the configuration, the route guidance can be displayed using the display device.

Further, in the intersection situation recognition system having the above-described configuration, the display device preferably displays route guidance on a screen, and displays the received image on the screen in overlapping relation on the route guidance.

According to the configuration, the image pickup direction of the intersection image can be recognized on the route guidance screen.

Moreover, in the intersection situation recognition system having the above-described configuration, the in-vehicle device preferably requests the image pickup device installed in the vicinity of the intersection to pick up an image of the intersection when the vehicle in which the in-vehicle device is mounted is about to enter the intersection, and the image pickup device preferably performs image pickup only when the request for the image pickup is made from the in-vehicle device mounted in the vehicle that is about to enter the intersection.

According to the configuration, since a configuration can be adopted in which the image pickup is not performed while no vehicle passes by, power consumption can be reduced.

Furthermore, in the intersection situation recognition system having the above-described configuration, the image pickup device preferably has a transmission rate measurement unit for measuring a transmission rate between the image pickup device and the in-vehicle device, and preferably performs at least one of a change of an image process content, a change of a bit rate of an image, and a change of an image size stepwise in accordance with the transmission rate as a measurement result by the transmission rate measurement unit.

According to the configuration, even when the transmission rate between the image pickup device and the in-vehicle device is reduced, the intersection image can be transmitted from the image pickup device to the in-vehicle device in real time.

An image pickup device of the present invention is installed in an vicinity of an intersection, picks up an image of a direction not visible from a vehicle that is about to enter the intersection, and transmits the picked-up image to the vehicle that is about to enter the intersection.

The image pickup device has an image pickup device identification number setting unit for setting a unique image pickup device identification number, an image pickup unit for picking up an image of an intersection situation, an image pickup device-side reception unit for receiving an image pickup device identification number transmitted from an in-vehicle device mounted in the vehicle that is about to enter the intersection, an image pickup device-side identification number comparison unit for comparing the image pickup device identification number received by the image pickup device-side reception unit with the unique image pickup device identification number set in the image pickup device and detecting a match between the image pickup device identification numbers, a transmission judgment unit for judging whether or not transmission is permitted in accordance with a result of the match detection by the image pickup device-side identification number comparison unit, and an image pickup device-side transmission unit for transmitting the image picked up by the image pickup unit and the unique image pickup device identification number to the in-vehicle device mounted in the vehicle that is about to enter the intersection when the image pickup device identification numbers match with each other and the transmission judgment unit judges that the transmission is permitted.

According to the configuration, since the situation of the road in the blind spot can be grasped before the vehicle enters the intersection by configuring the intersection situation recognition system in combination with the in-vehicle device of the present invention, it is possible to significantly reduce the possibility of occurrence of the crash or the physical injury. In addition, since the image pickup device is assigned with the image pickup device identification number, it is possible to identify the image pickup device installed at the intersection that the vehicle is about to enter without misrecognition. Consequently, the situation of the road in the blind spot can be reliably grasped.

In addition, in the above-described image pickup device of the present invention, the image pickup device-side reception unit preferably receives an in-vehicle device identification number transmitted from the in-vehicle device mounted in the vehicle that is about to enter the intersection, and the image pickup device-side transmission unit preferably transmits the in-vehicle device identification number to the in-vehicle device mounted in the vehicle that is about to enter the intersection.

According to the configuration, it is possible to avoid the displaying of the image transmitted to the in-vehicle device mounted in another vehicle running in the same intersection by mistake.

Further, the image pickup device of the present invention preferably includes a transmission unit for transmitting image pickup device installation information including positional information, an image pickup direction, and the image pickup device identification number of the image pickup device to a surrounding area.

According to the configuration, even when a new image pickup device is additionally installed at the intersection, the in-vehicle device can automatically obtain the image pickup device installation information including the positional information, the image pickup direction, and the image pickup device identification number of the pickup device only by the running of the vehicle in which the in-vehicle device is mounted in the vicinity of the intersection so that it is not necessary to perform additional work such as periodically asking the in-vehicle device manufacturer or the dealer to update the image pickup device installation information in the image pickup device retrieval unit of the in-vehicle device, or downloading the image pickup device information on the Internet to update the image pickup device retrieval unit using the data.

Moreover, in the image pickup device of the present invention, the image pickup device-side reception unit preferably receives a priority of the image pickup device from the in-vehicle device mounted in the vehicle that is about to enter the intersection, and the image pickup device of the present invention preferably further includes an image quality determination unit for determining an image quality of the image to be transmitted to the in-vehicle device mounted in the vehicle that is about to enter the intersection in accordance with the priority of the image pickup device received by the image pickup device-side reception unit, and an image processing unit for performing image processing on the image picked up by the image pickup unit in accordance with the image quality determined by the image quality determination unit.

According to the configuration, since the image of the image pickup direction having high priority is displayed with high image quality and the image having low priority is displayed with low image quality, it becomes possible to recognize the situation of the intersection with increased accuracy, and the safety when the vehicle passes through the intersection can be enhanced.

Furthermore, the image pickup device of the present invention preferably performs image pickup only when a request for the image pickup is made from the in-vehicle device mounted in the vehicle that is about to enter the intersection.

According to the configuration, since the configuration can be adopted in which the image pickup is not performed while no vehicle passes by, power consumption can be reduced.

In addition, the image pickup device of the present invention preferably further includes a transmission rate measurement unit for measuring a transmission rate between the image pickup device and the in-vehicle device, wherein at least one of a change of an image process content, a change of a bit rate of an image, and a change of an image size is preferably performed stepwise in accordance with the transmission rate as a measurement result by the transmission rate measurement unit.

According to the configuration, even when the transmission rate between the image pickup device and the in-vehicle device is reduced, the intersection image can be transmitted from the image pickup device to the in-vehicle device in real time.

An in-vehicle device of the present invention is mounted in a vehicle that is about to enter an intersection, and receives and displays an image from an image pickup device installed in a vicinity of the intersection.

The in-vehicle device includes a vehicle position detection unit for detecting a position of the vehicle in which the in-vehicle device is amounted and a running direction thereof, an image pickup device retrieval unit for determining the intersection that the vehicle is about to enter from the position of the vehicle and the running direction thereof, and retrieving an image pickup device identification number in correspondence to the image pickup device installed in the vicinity of the determined intersection, an in-vehicle device-side transmission unit for transmitting the image pickup device identification number retrieved by the image pickup device retrieval unit to the image pickup device installed in the vicinity of the intersection, an in-vehicle device-side reception unit for receiving the image and an image pickup device identification number transmitted from the image pickup device installed in the vicinity of the intersection, an in-vehicle device-side identification number comparison unit for comparing the image pickup device identification number received by the in-vehicle device-side reception unit with the image pickup device identification number retrieved by the image pickup device retrieval unit, and detecting a match between the image pickup device identification numbers, and a display device for displaying the image received from the image pickup device in correspondence to the image pickup device identification numbers between which the match is detected by the in-vehicle device-side identification number comparison unit.

According to the configuration, since the situation of the road in the blind spot can be grasped before the vehicle enters the intersection by configuring the intersection situation recognition system in combination with the image pickup device of the present invention, it is possible to significantly reduce the possibility of occurrence of the crash or the physical injury. In addition, since the image pickup device is assigned with the image pickup device identification number, it is possible to identify the image pickup device installed at the intersection that the vehicle is about to enter without misrecognition. Consequently, the situation of the road in the blind spot can be reliably grasped.

In the above-described in-vehicle device of the present invention, the image pickup device retrieval unit preferably pre-records positional information, an image pickup direction, and the image pickup device identification number of the image pickup device in association with each other.

According to the configuration, it is not necessary to constantly transmit the positional information, the image pickup direction, and the image pickup device identification number of the image pickup device from the image pickup device to a surrounding area to inform the in-vehicle device mounted in the vehicle running in the surrounding area of them, and it is possible to retrieve the identification number of the image pickup device installed at the intersection that the vehicle is about to enter only on the in-vehicle device side.

The above-described in-vehicle device of the present invention preferably further includes an image pickup device installation information reception unit for receiving image pickup device installation information including positional information, an image pickup direction, and the image pickup device identification number of the image pickup device.

According to the configuration, even when a new image pickup device is additionally installed at the intersection, the in-vehicle device can automatically obtain the image pickup device installation information including the positional information, the image pickup direction, and the image pickup device identification number of the image pickup device only by the running of the vehicle in which the in-vehicle device is mounted in the vicinity of the intersection so that it is not necessary to perform additional work such as periodically asking the in-vehicle device manufacturer or the dealer to update the image pickup device installation information in the image pickup device retrieval unit, or downloading the image pickup device information on the Internet to update the image pickup device retrieval unit using the data.

In the above-described in-vehicle device of the present invention, the image pickup device retrieval unit preferably records the positional information, the image pickup direction, and the image pickup device identification number of the image pickup device received by the image pickup device installation information reception unit in association with each other.

According to the configuration, since it is possible to record the positional information, the image pickup direction, and the image pickup device identification number of the image pickup device as a database once the vehicle runs through the intersection, it is possible to quickly retrieve the image pickup device installed at the intersection when the vehicle enters the intersection.

The above-described in-vehicle device of the present invention preferably further includes a priority judgment unit for assigning priorities to a plurality of image pickup devices based on an image pickup direction of the plurality of image pickup devices and the running direction of the vehicle in which the in-vehicle device is mounted in a state where the plurality of image pickup devices are installed at the intersection that the vehicle is about to enter, wherein the in-vehicle device-side transmission unit preferably transmits the priorities of the plurality of image pickup devices assigned by the priority judgment unit in association with the image pickup device identification number.

According to the configuration, since the image of the image pickup device having high priority can be preferentially displayed in accordance with the running direction of the vehicle, the safety when the vehicle passes through the intersection can be enhanced.

In the above-described in-vehicle device of the present invention, the priority judgment unit preferably assigns the priorities in accordance with route guidance of a route guidance device mounted in the vehicle in which the in-vehicle device is mounted.

In the above-described in-vehicle device of the present invention, the priority judgment unit preferably assigns the priorities in accordance with a direction of a direction indicator of the vehicle in which the in-vehicle device is mounted.

The above-described in-vehicle device of the present invention preferably further includes an in-vehicle device identification number setting unit for setting a unique in-vehicle device identification number, wherein the in-vehicle device-side transmission unit preferably transmits the unique in-vehicle device identification number to the image pickup device installed in the vicinity of the intersection, the in-vehicle device-side reception unit preferably receives the in-vehicle device identification number transmitted from the image pickup device installed in the vicinity of the intersection, the in-vehicle device-side identification number comparison unit preferably compares the in-vehicle device identification number received by the in-vehicle device-side reception unit with the in-vehicle device identification number unique to the in-vehicle device, and detects a match between the in-vehicle device identification numbers, and the display device preferably displays the image received from the image pickup device in correspondence to the image pickup device identification numbers between which the match is detected by the in-vehicle device-side identification number comparison unit when the match between the in-vehicle device identification number received by the in-vehicle device-side reception unit and the in-vehicle device identification number unique to the in-vehicle device is detected by the in-vehicle device-side identification number comparison unit.

According to the configuration, it is possible to avoid the displaying of the image transmitted to the in-vehicle device mounted in another vehicle running in the same intersection by mistake.

In the above-described in-vehicle device of the present invention, the display device preferably displays the received image on an entire screen.

According to the configuration, since the image of the intersection can be displayed largely, the situation of the intersection is easily recognized.

In the above-described in-vehicle device of the present invention, the display device preferably divides a screen, and displays the received image on a part of the screen and displays another image on a remaining portion of the screen simultaneously with the received image.

According to the configuration, the display device can be effectively used for other purposes.

In the above-described in-vehicle device of the present invention, the another image is preferably an image showing route guidance.

According to the configuration, the route guidance can be displayed using the display device.

In the above-described in-vehicle device of the present invention, the display device preferably displays route guidance on a screen, and displays the received image on the screen in overlapping relation on the route guidance.

According to the configuration, the image pickup direction of the intersection image can be recognized on the route guidance screen.

The above-described in-vehicle device of the present invention preferably requests the image pickup device installed in the vicinity of the intersection to pick up an image of the intersection when the vehicle in which the in-vehicle device is mounted is about to enter the intersection.

According to the configuration, since the configuration can be adopted in which the image pickup is not performed while no vehicle passes by, power consumption can be reduced.

### ADVANTAGEOUS EFFECTS OF INVENTION

According to the present invention, since the situation of the road in the blind spot can be grasped before the vehicle enters the intersection, it is possible to significantly reduce the possibility of occurrence of the crash or the physical injury. In addition, since the image pickup device is assigned with the image pickup deice identification number, it is possible to identify the image pickup device installed at the intersection that the vehicle is about to enter without misrecognition. Consequently, the situation of the road in the blind spot can be reliably grasped.

### BRIEF DESCRIPTION OF DRAWINGS

FIG. 1 is a block diagram showing an entire configuration of an intersection situation recognition system according to a first embodiment of the present invention;

FIG. 2 is a view showing an overall flow of the intersection situation recognition system according to the first embodiment of the present invention;

FIG. 3 is a schematic view showing a first example of an intersection situation;

FIG. 4 is a view showing an example of a display image at the time of an entire screen display;

FIG. 5 is a view showing a first example of the display image at the time of a screen division display;

FIG. 6 is a schematic view showing a second example of the intersection situation;

FIG. 7 is a view showing a second example of the display image at the time of the screen division display;

FIG. 8 is a view showing an example of the display image at the time of an overlap display;

FIG. 9 is a block diagram showing an entire configuration of an intersection situation recognition system according to a second embodiment of the present invention;

FIG. 10 is a view showing a reception flow of image pickup device installation information in the intersection situation recognition system according to the second embodiment of the present invention;

FIG. 11A is a view showing an example of the intersection situation for explaining priorities of a plurality of image pickup devices;

FIG. 11B is a view showing an example of priorities of image pickup directions of the plurality of image pickup devices to running directions of a vehicle;

FIG. 12 is a block diagram showing an entire configuration of an intersection situation recognition system according to a third embodiment of the present invention;

FIG. 13A is a view showing an example of the intersection situation for explaining priorities of a plurality of image pickup devices when a plurality of vehicles enter the same intersection;

FIG. 13B is a view showing an example of priorities of the image pickup directions of the plurality of image pickup devices to the running directions of the vehicles when the plurality of vehicles enter the same intersection;

FIG. 14 is a view showing an overall flow of the intersection situation recognition system according to the third embodiment of the present invention;

FIG. 15 is a block diagram showing an entire configuration of an intersection situation recognition system according to a fourth embodiment of the present invention;

FIG. 16A is a view showing a process determination flow when a transmission rate is lowered in the intersection situation recognition system according to the fourth embodiment of the present invention; and

FIG. 16B is a view showing a relation between the transmission rate and a process content in the process determination flow when the transmission rate is lowered.

### DESCRIPTION OF EMBODIMENTS

A description will be given hereinbelow of embodiments of the present invention with reference to the drawings. It is to be noted that the embodiments described below are only illustrative, and various modifications including modified embodiments described later can be made.

### First Embodiment

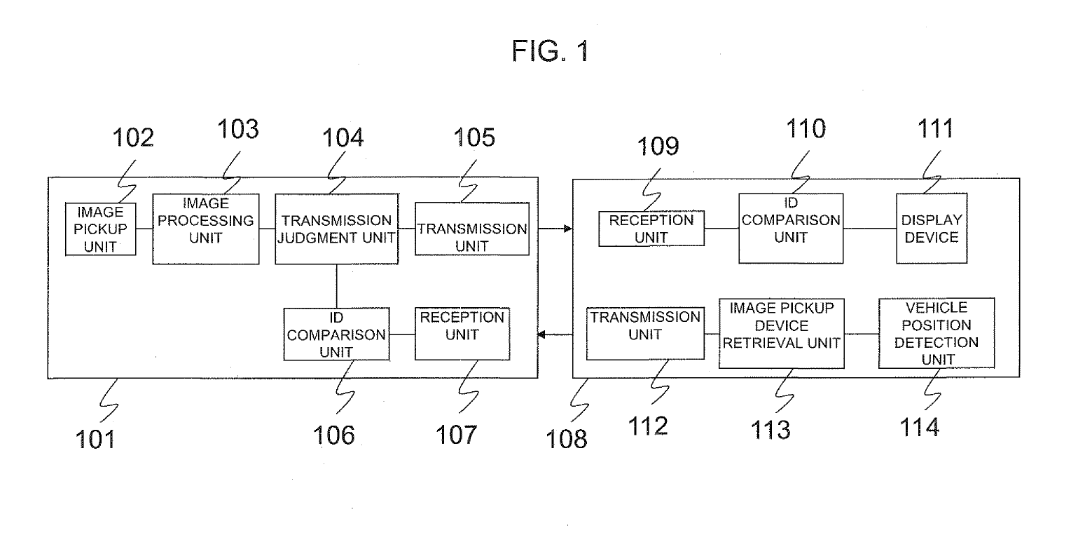

FIG. 1 is a block diagram showing an entire configuration of an intersection situation recognition system in a first embodiment of the present invention.

The intersection situation recognition system in the present first embodiment includes an image pickup device 101 and an in-vehicle device 108. The image pickup device 101 and the in-vehicle device 108 have their respective unique identification numbers (IDs). For the communication between the in-vehicle device 108 and the image pickup device 101, wireless communication using light, radio waves or the like is utilized. It is to be noted that the term “identification number” includes identification codes made of signs other than numbers or combinations of numbers and the signs other than numbers.

The image pickup device 101 includes an image pickup unit 102 having a lens, an image pickup element, and an analog front end for converting an picked-up image to a digital picked-up image signal, an image processing unit 103 for performing specific processing (color correction, YC processing, and MPEG/JPEG compression) on the image signal from the image pickup unit 102, a reception unit 107 for receiving the identification number (ID) from the in-vehicle device 108, an ID comparison unit 106 for comparing the ID received by the reception unit 107 with an ID set in the image pickup device 101, a transmission judgment unit 104 for judging whether or not the image is transmitted to the in-vehicle device 108 according to the comparison result of the ID comparison unit 106, and a transmission unit 105 for transmitting the image and the ID of the image pickup device 101.

The in-vehicle device 108 includes a vehicle position detection unit 114 for detecting a position and a running direction of a vehicle in which the in-vehicle device 108 is mounted, an image pickup device retrieval unit 113 for retrieving the ID of the image pickup device 101 installed at an intersection that the vehicle is about to enter, a transmission unit 112 for transmitting the ID retrieved by the image pickup device retrieval unit 113 to the image pickup device 101, a reception unit 109 for receiving the image and the ID of the image pickup device 101 from the image pickup device 101, an ID comparison unit 110 for comparing the received ID of the image pickup device 101 with the ID of the image pickup device 101 installed at the intersection that the vehicle is about to enter, and a display device 111 for displaying the image received from the image pickup device 101. In the image pickup device retrieval unit 113, the position and the ID of each of the image pickup devices 101 installed nationwide are pre-recorded.

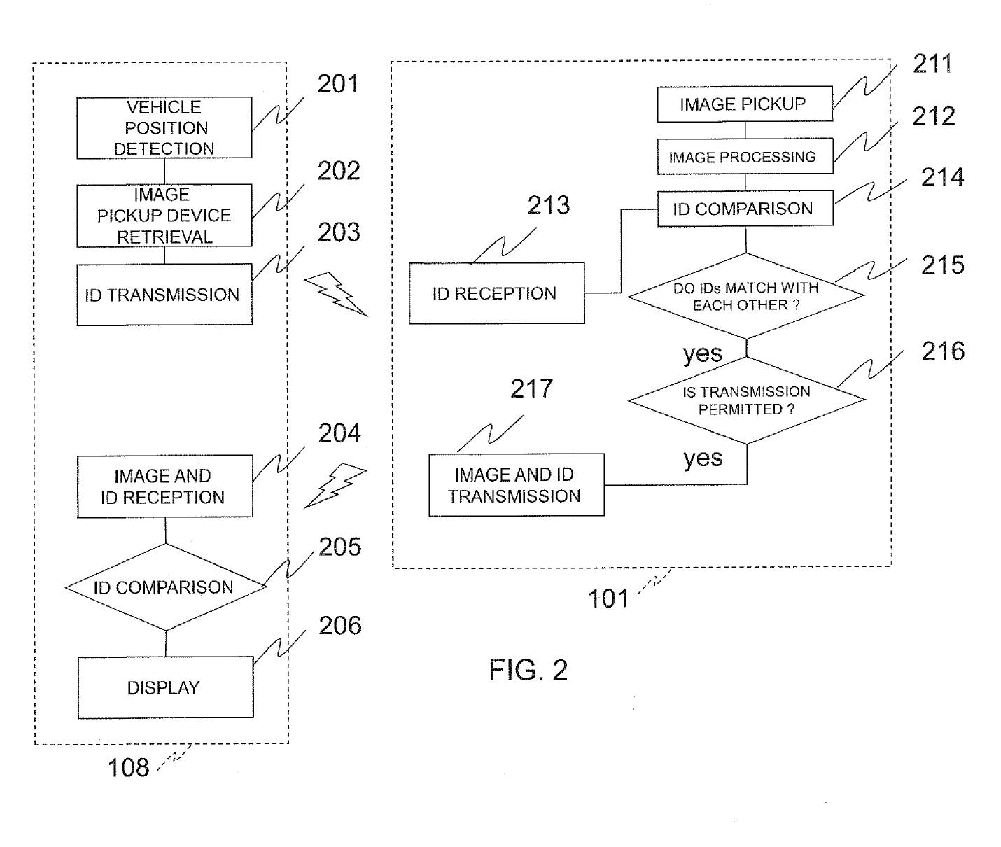

FIG. 2 shows an overall flow of the intersection situation recognition system in the present first embodiment. First, the position and and the running direction of the vehicle in which the in-vehicle device 108 is mounted are detected using the vehicle position detection unit 114 of the in-vehicle device 108 (vehicle position detection step 201). Although a device dedicated to the present system may be used as the vehicle position detection unit 114, an existing car navigation system may simply be used. When the position and the running direction of the vehicle are detected, it becomes possible to determine the intersection that the vehicle is about to enter.

Next, an ID of the image pickup device 101 installed at the intersection that the vehicle is about to enter is retrieved using the image pickup device retrieval unit 113 (image pickup device retrieval step 202). When a plurality of image pickup devices 101 are installed at the intersection, only a necessary ID of the image pickup device 101 is retrieved. For example, the image from an image pickup device 101 that is picking up the image of the road on which the vehicle is running is not necessary so that the image pickup device 101 is not retrieved.

When the retrieval of the ID is completed, the ID is transmitted to the image pickup device 101 (ID transmission step 203).

When the image pickup device 101 receives the ID (ID reception step 213), the image pickup device 101 compares an ID set in the image pickup device 101 with the received ID (ID comparison step 214). Herein, the reason for the comparison of the IDs is to transmit only the image of the image pickup device 101 needed by the in-vehicle device 108. The reason for the comparison thereof is that, when an image pickup device in the vicinity of the image pickup device 101 needed by the in-vehicle device 108 receives the ID, a wrong image is transmitted to the in-vehicle device 108.

When the IDs match with each other (ID match 215), information indicating that image transmission is permitted is transferred to the transmission judgment unit 104. At this point, the image pickup device 101 is performing image pickup (image pickup step 211) and image processing (image processing step 212), and is picking up the image to be transmitted.

Next, it is judged whether or not the transmission is permitted in the transmission judgment unit 104 (transmission permission judgment step 216). When the IDs match with each other in the ID comparison unit 106, the transmission is permitted. When the transmission is permitted, the ID of the image pickup device 101 and the picked-up image are transmitted to the in-vehicle device 108 (image and ID transmission step 217).

When the in-vehicle device 108 receives the ID and the image (image and ID reception step 204), the received ID is compared with the retrieved ID in the ID comparison unit 110 to find out whether or not the IDs match with each other (ID comparison step 205). When the IDs match with each other, the matching ID is displayed on the display device 111 (display step 206).

Although a display device dedicated to the present system may be used as the display device 111, a monitor of an existing car navigation system may simply be used.

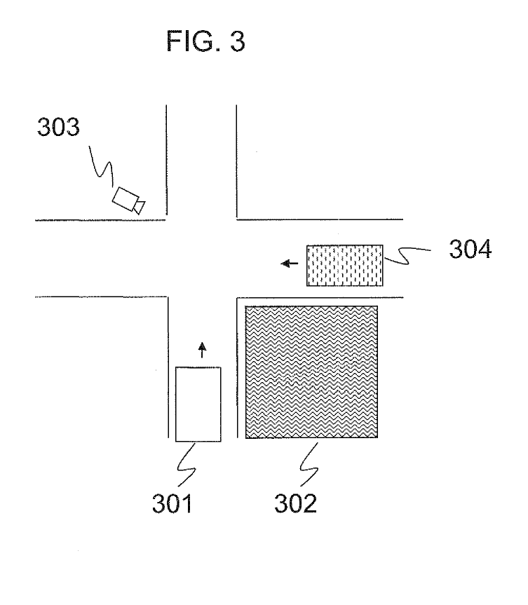

Examples of a display method will be described. The description will be given on the basis of an example of an intersection situation shown in FIG. 3. In the situation in FIG. 3, a vehicle 301 is about to enter an intersection. The intersection has good visibility in a left direction, while having poor visibility in a right direction due to an obstacle 302 positioned in the right direction. An image of the situation of a road with poor visibility is picked up by an image pickup device 303, and another vehicle 304 on the road is about to enter the same intersection. The vehicle 301 receives the image in accordance with the flow in FIG. 2, and displays the image on the display device.

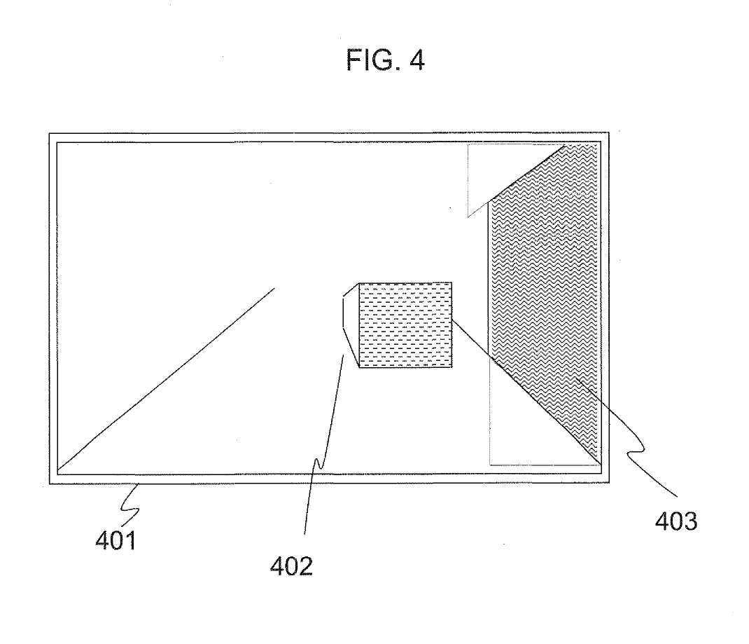

As the first example of the display, there is a method of displaying the received image on the entire screen of the display device. FIG. 4 is a view showing a display image at the time of an entire screen display. The received image is displayed on the entire screen of a display device 401. A reference sign 402 denotes another vehicle corresponding to the another vehicle 304 in FIG. 3, while a reference sign 403 similarly denotes an obstacle corresponding to the obstacle 302 in FIG. 3. By adopting the entire screen display, the situation of the road in the blind spot can be recognized in detail.

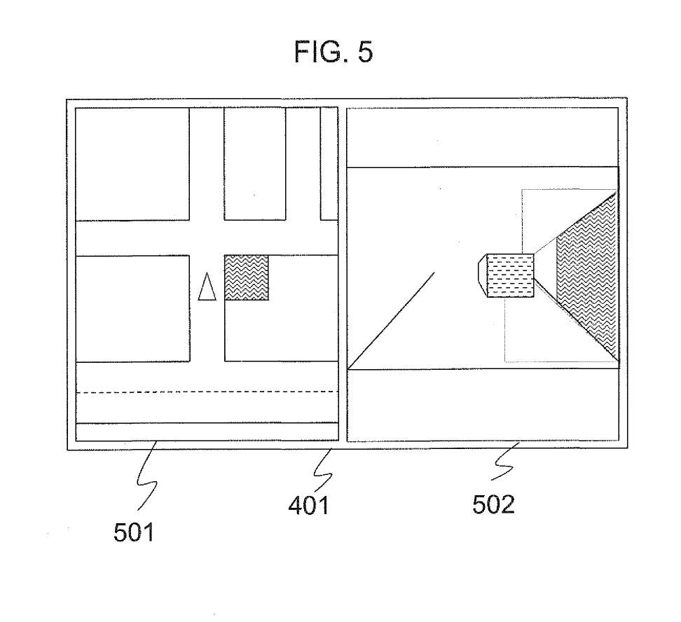

The second example is a method of displaying by dividing the screen of the display device into, e.g., two. FIG. 5 is a view showing a display image when a screen division display is performed in the display device 401. A received image 502 from the image pickup device is displayed on the right half of the screen of the display device 401 in FIG. 5, while a car navigation system image 501 is displayed on the left half of the screen of the display device 401. When the screen of the display device 401 is divided to display the images, the display of the received image is small in size, and visibility is reduced when compared with the entire screen display. However, the screen division display is convenient because the route guidance of the car navigation system or the like can also be displayed simultaneously. In this example, although the received image 502 is displayed on the right half of the screen of the display device 401 and the car navigation system image 501 is displayed on the left half of the screen, the display areas on the screen may also be reversed. When the picked-up image of the left direction from the intersection is received, it is appropriate to display the received image 502 on the left half of the screen. By matching the image pickup direction with the left or right side of the display screen, it becomes easier to sensuously recognize which direction of which the image is picked up. Herein, although the lateral division has been shown as the example, the screen may also be vertically divided.

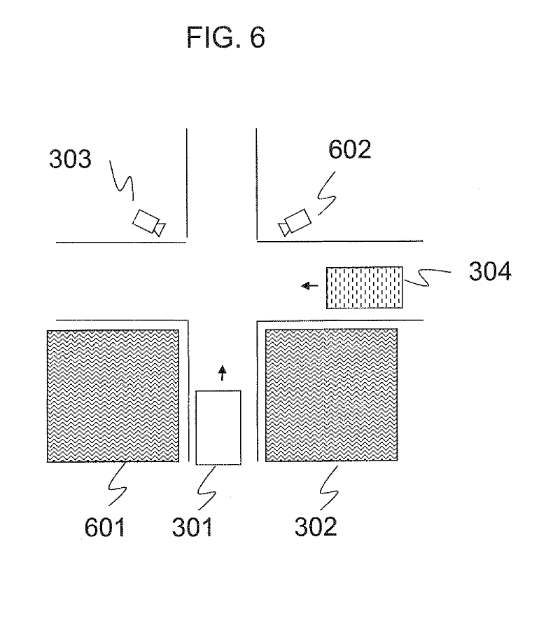

Next, a description will be given by using an example of the intersection situation in FIG. 6. The intersection situation in FIG. 6 is a situation in which an obstacle 601 is additionally present on the left side in the intersection situation in FIG. 3 so that the visibility is further reduced, and an image pickup device 602 for picking up the image of the road situation on the left side is additionally installed at the intersection. In this case, the vehicle needs to receive and display images from two image pickup devices.

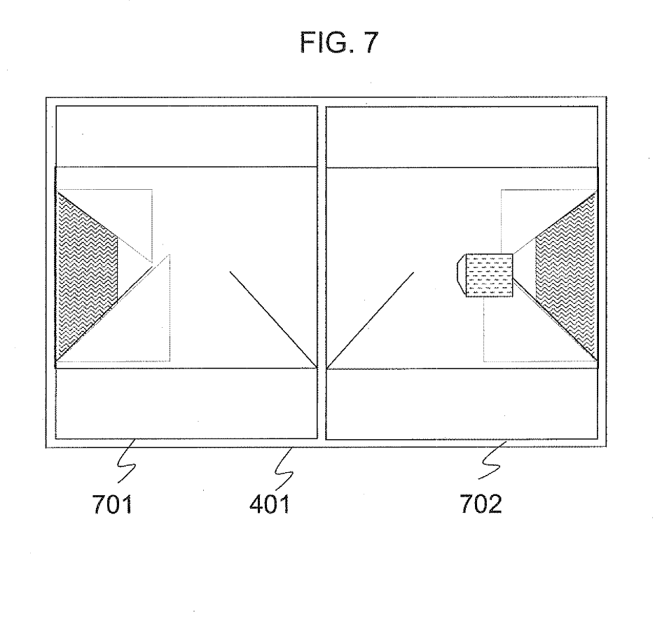

FIG. 7 is an image view when two received images are displayed on one display screen of the display device 401. An intersection right-side image 702 is displayed on the right half of the screen of the display device 401, while an intersection left-side image 701 is displayed on the left-half of the screen of the display device 401. At this point as well, by matching the image pickup directions with the left and right sides of the display screen, it becomes easier to sensuously recognize which direction of which the image is picked up.

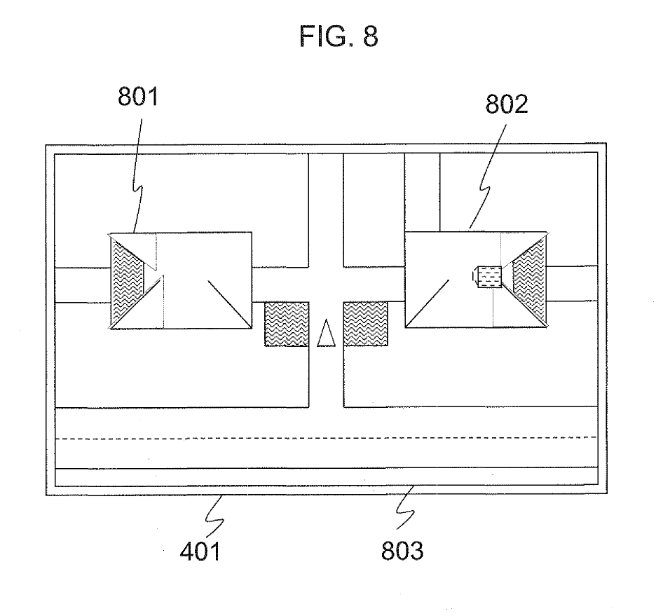

The next display example is a method of displaying the car navigation system image on the entire display screen of the display device 401, and displaying the received image in overlapping relation on the car navigation system image. The description will be given by using FIG. 8. A car navigation system image 803 is displayed on the entire screen of the display device 401, and a received intersection left-side image 801 and a received intersection right-side image 802 are displayed on a part of the screen of the display device 401 in overlapping relation on the ear navigation system image 803. Although the received images are further reduced in size, the method is convenient because it is possible to simultaneously display the route guidance of the car navigation system and the like, and also recognize the intersection situation. The intersection left-side image 801 and the intersection right-side image 802 are preferably displayed so as to be overlapped on the corresponding portions of the road of which the images are picked up on the car navigation system image 803 as shown in the drawing, because it becomes easier for a driver to grasp the intersection situation.

### Second Embodiment

In the foregoing, although the description has been given on the assumption that the positions and IDs of the image pickup devices installed nationwide are pre-recorded in the image pickup device retrieval unit 113, a description will be given herein of an embodiment in a case where the positions and IDs are not pre-recorded.

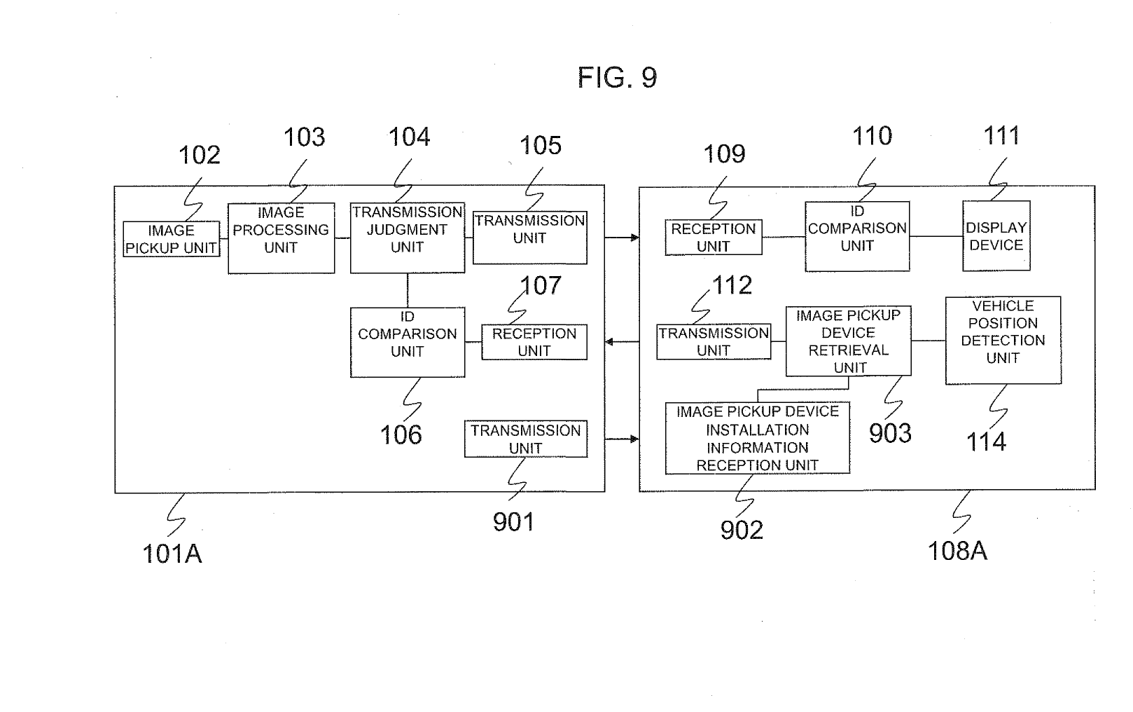

FIG. 9 is a block diagram showing an entire configuration of an intersection situation recognition system in a second embodiment of the present invention. The entire configuration in FIG. 9 is obtained by adding a transmission unit 901 and an image pickup device installation information reception unit 902 as new blocks to FIG. 1 as the entire configuration of the above-described first embodiment. A device in which the new block is added to the image pickup device 101 in FIG. 1 is an image pickup device 101A, and a device in which the new block is added to the in-vehicle device 108 is an in-vehicle device 108A.

The image pickup device 101A has a configuration in which the transmission unit 901 for transmitting positional information, the image pickup direction, and the ID of the image pickup device 101A to a surrounding area is added to the image pickup device 101 in FIG. 1.

The in-vehicle device 108A has a configuration in which the image pickup device installation information reception unit 902 for receiving the positional information, the image pickup direction, and the ID of the image pickup device transmitted by the image pickup device 101A is added to the in-vehicle device 108 in FIG. 1, and the received image pickup device installation information is stored in an image pickup device retrieval unit 903 provided instead of the image pickup device retrieval unit 103 in FIG. 1.

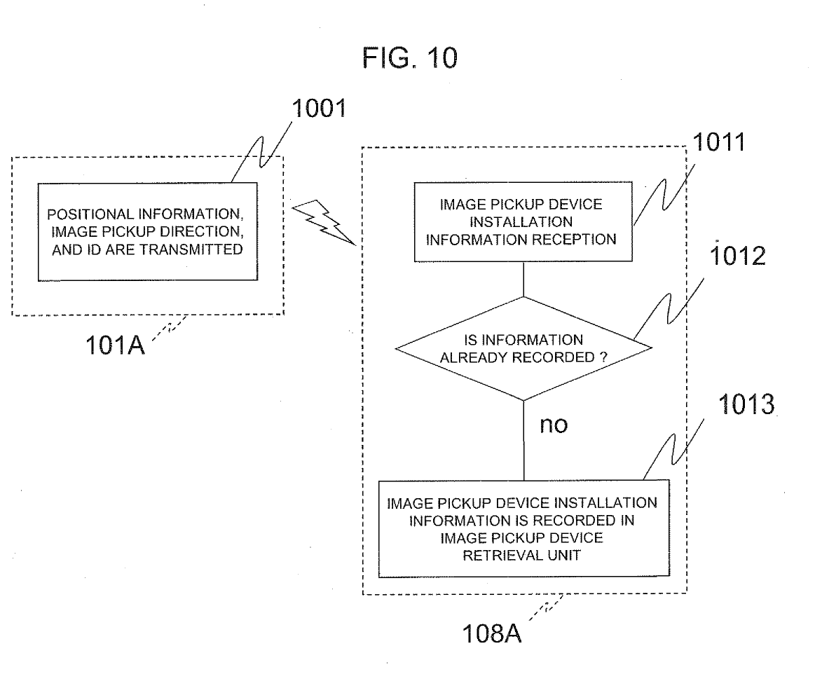

FIG. 10 shows an image pickup device installation information reception flow in the present second embodiment. The image pickup device 101A transmits the image pickup device installation information including the installation position, the image pickup direction, and the ID of the image pickup device 101A to the surrounding area thereof (positional information, image pickup direction, and ID transmission step 1001). When the in-vehicle device 108A of a vehicle running in the surrounding area of the image pickup device 101A receives the image pickup device installation information (image pickup device installation information reception step 1011), the in-vehicle device 108A judges whether or not the received image pickup device installation information is information that is already recorded in the image pickup device retrieval unit 903 (step of judging whether or not information is already recorded 1012). When the received image pickup device installation information is not recorded information, the received image pickup device installation information is recorded in the image pickup device retrieval unit 903 (step of recording image pickup device installation information in image pickup device retrieval unit 1013).

With the operation described above, the necessity for the step of pre-recording the image pickup device information in the image pickup device retrieval unit 903 in the manufacturing stage of the in-vehicle device 108A is obviated. In addition, even when the image pickup device information is pre-recorded, in a case where the image pickup device 101A is newly installed, additional work such as asking an in-vehicle device manufacturer or a dealer to update the image pickup device information, or downloading the image pickup device information on the Internet to update the image pickup device retrieval unit 903 using the data is required in the first embodiment, but the additional work is not required in the second embodiment.

### Third Embodiment

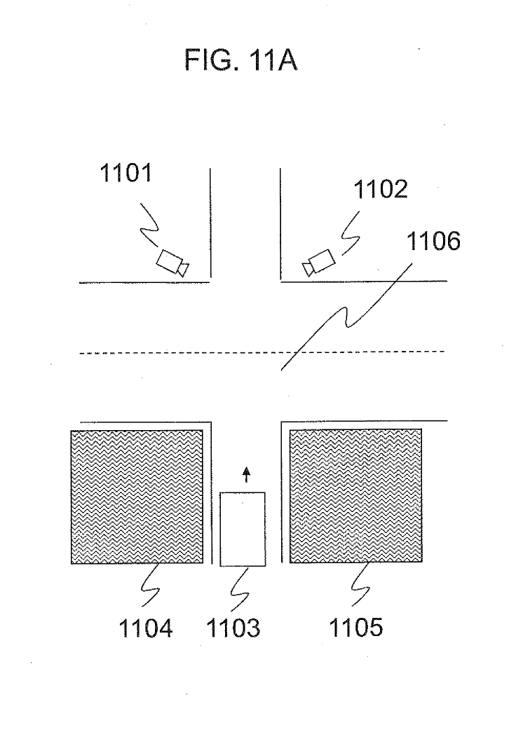

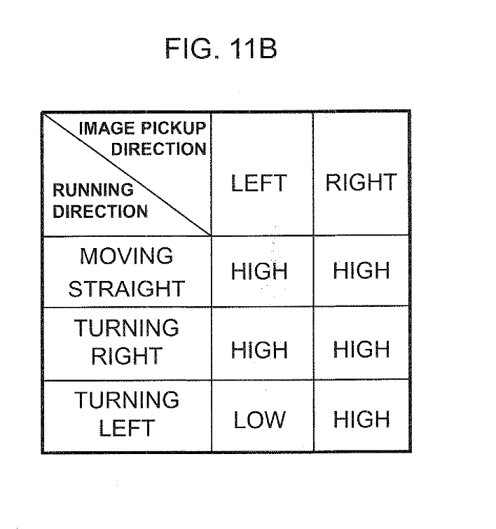

In the first embodiment, when the images are received from a plurality of image pickup devices, all of the images are displayed in the same manner. However, as shown in FIG. 11A, when two image pickup devices 1101 and 1102 are installed at an intersection 1106 with obstacles 1104 and 1105, there are cases where priorities of images of the image pickup devices 1101 and 1102 are changed depending on the direction in which a vehicle 1103 moves. For example, in FIG. 11A, when the vehicle 1103 moves straight through the intersection 1106 or turns right at the intersection 1106, the images on the left and the right have the same priority. On the other hand, when the vehicle 1103 turns left at the intersection 1106, the image of the road on the right side picked up by the image pickup device 1101 is higher in priority than the image of the road on the left side picked up by the image pickup device 1102. In this case, it is appropriate to preferentially display the right-side image. FIG. 11B shows the relation of the priority of a left or right image-pickup direction to the running direction of the vehicle at the intersection.

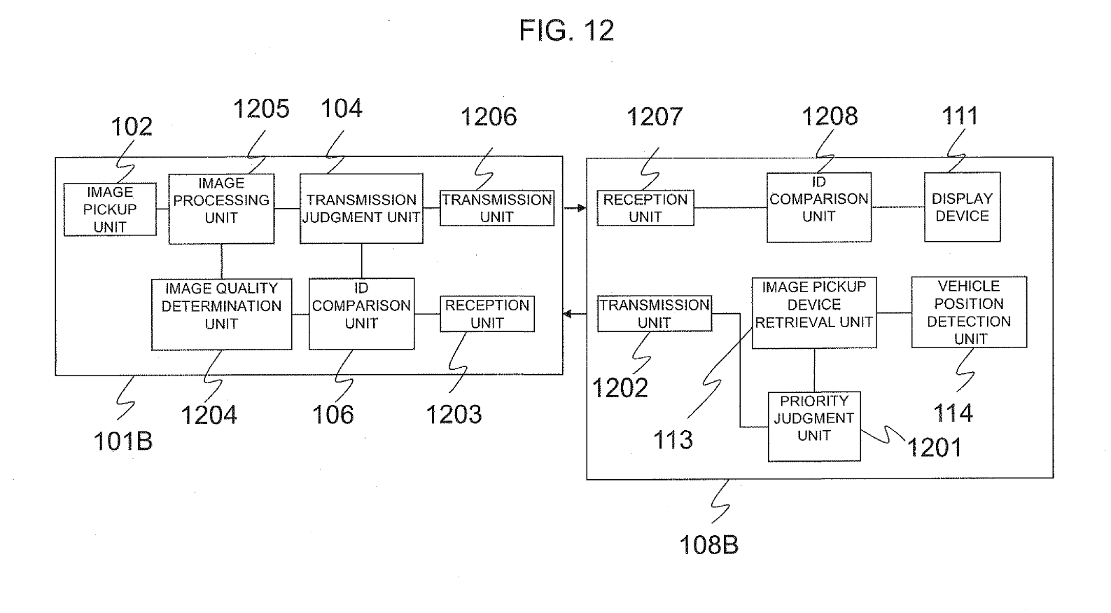

FIG. 12 is a block diagram showing an entire configuration of an intersection situation recognition system in a third embodiment of the present invention. The entire configuration in FIG. 12 is obtained by adding a priority judgment unit 1201 and an image quality determination unit 1204 as new blocks to FIG. 1 as the entire configuration of the above-described first embodiment, and replacing the transmission unit 112, the reception unit 109, the ID comparison unit 110, the transmission unit 105, the reception unit 107, and the image processing unit 103 with a transmission unit 1202, a reception unit 1207, an ID comparison unit 1208, a transmission unit 1206, a reception unit 1203, and an image processing unit 1205. A device in which the block is newly added to the image pickup device 101 in FIG. 1 is an image pickup device 101B, and a device in which the block is newly added to the in-vehicle device 108 in FIG. 1 is an in-vehicle device 108B.

The in-vehicle device 108B has a configuration in which the priority judgment unit 1201 is newly provided, and the transmission unit 1202 transmits not only the ID of the image pickup device retrieved by the image pickup device retrieval unit 113 but also the priority judged by the priority judgment unit 1201 and the ID of the in-vehicle device 108B. In addition, in the above-described configuration, the reception unit 1207 receives not only the ID and the image of the image pickup device but also the ID of the in-vehicle device, and the ID comparison unit 1208 compares not only the IDs of the image pickup device but also the IDs of the in-vehicle device.

The image pickup device 101B has a configuration in which the image quality determination unit 1204 is additionally provided, the reception unit 1203 receives the ID of the image pickup device, the ID of the in-vehicle device, and the priority, the image processing unit 1205 creates an image having image quality in accordance with the result of the image quality determination unit 1204, and the transmission unit 1206 transmits the image, the ID of the image pickup device, and the ID of the in-vehicle device. When the priority is “low”, the image processing unit 1205 creates an image having low image quality, while when the priority is “high”, the image processing unit 1205 creates an image having high image quality.

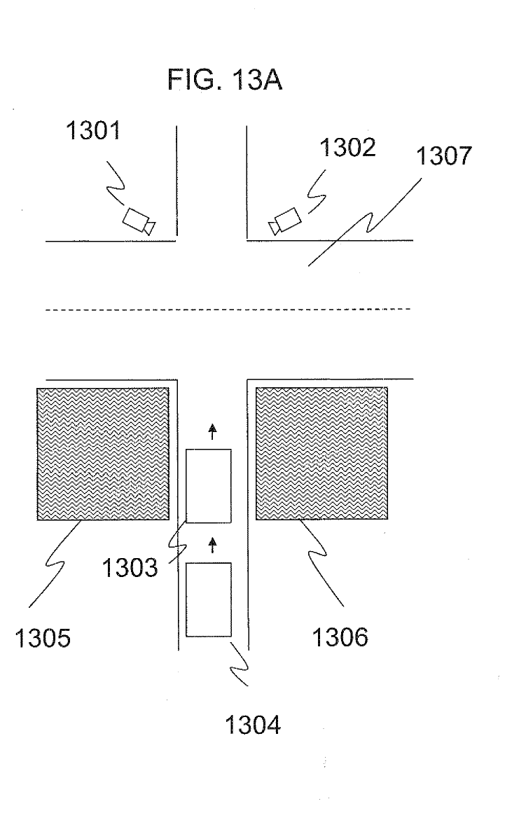

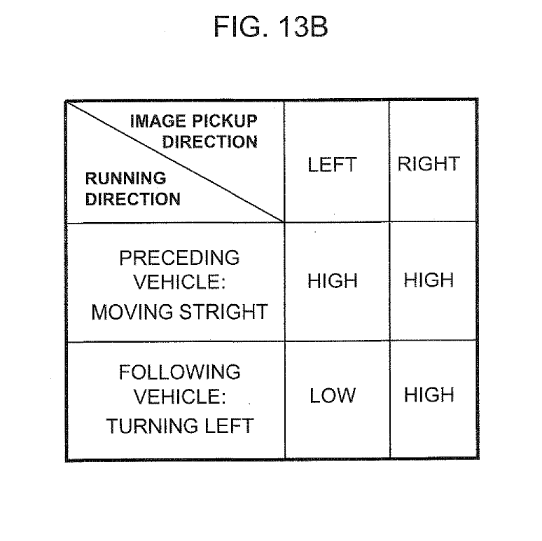

Herein, the reason for the comparison of the IDs of the in-vehicle device will be described by using FIGS. 13A and 13B. FIG. 13A is a view showing a situation in which a preceding vehicle 1303 planning to move straight and a following vehicle 1304 planning to turn left are about to enter an intersection 1307 at which an image pickup device 1301 and an image pickup device 1302 are installed. FIG. 13B is a view showing the relation between the running direction of the vehicle and the priority of the image pickup direction.

Since the preceding vehicle 1303 plans to move straight through the intersection 1307, as shown in FIG. 13B, the priorities of the image pickup device 1301 and the image pickup device 1302 are both “high”. However, since the following vehicle 1304 plans to turn left at the intersection 1307, the priority of the image pickup device 1301 is “high”, while the priority of the image pickup device 1302 is “low”.

In the situation described above, when the preceding vehicle 1303 has received the image having low image quality created for the following vehicle 1304 by the image pickup device 1302, the image having low image quality is displayed on the display device of the preceding vehicle 1303 so that the preceding vehicle 1303 may not be able to grasp the road situation in detail, which is dangerous. Consequently, it is necessary to compare the IDs of the in-vehicle device and not to display the image when the IDs do not match with each other.

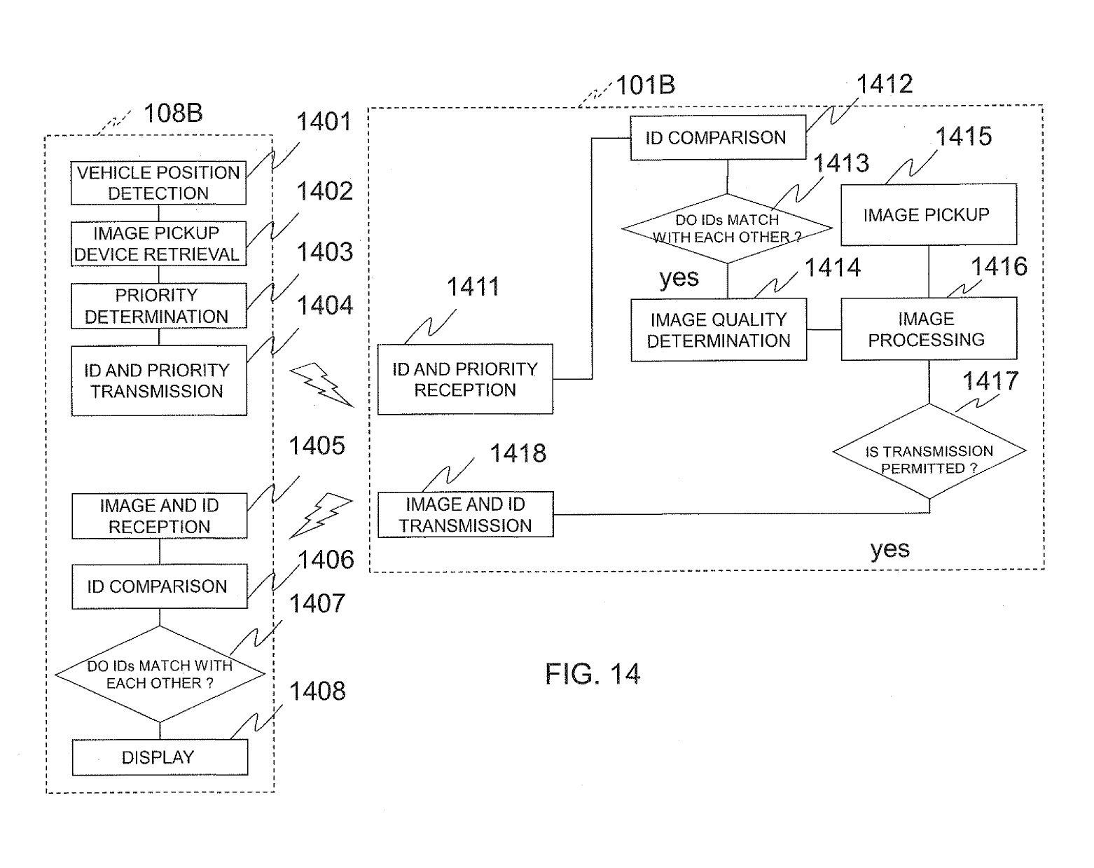

FIG. 14 shows an overall flow of the intersection situation recognition system in the present third embodiment. The flow is obtained by adding priority judgment and image quality determination to the flow in FIG. 2.

First, the position and the running direction of the vehicle in which the in-vehicle device 108B is mounted are detected by the vehicle position detection unit 114 of the in-vehicle device 108B (vehicle position detection step 1401). When the position and the running direction of the vehicle are detected, it becomes possible to determine the intersection that the vehicle is about to enter.

Next, the ID of the image pickup device 101B installed at the intersection that the vehicle is about to enter is retrieved by the image pickup device retrieval unit 113 (image pickup device retrieval step 1402).

When the retrieval of the ID is completed, the priority is determined by the priority judgment unit 1201 (priority judgment step 1403). Specifically, the running direction is firstly detected from the route guidance of the car navigation system or a direction indicator of the vehicle. The priority is determined in accordance with the detected running direction. For example, in FIG. 13A, when the route guidance of the car navigation system of the vehicle indicates left turn, or when the direction indicator indicates the left, the priority of the image pickup device 1301 is set to “high”, and the priority of the image pickup device 1302 is set to “low”.

When the determination of the priority is completed, the determined priority, the ID retrieved by the image pickup device retrieval unit 113, and the ID set in the in-vehicle device (in-vehicle device 108B) are transmitted to the image pickup device 101B (ID and priority transmission step 1404).

When the reception unit 1203 of the image pickup device 101 B receives the ID and the priority (ID and priority reception step 1411), the ID set in the image pickup device (image pickup device 101B) is compared with the received ID of the image pickup device (ID comparison step 1412).

When the IDs match with each other, information indicating that image transmission is permitted is transferred to the transmission judgment unit 104, and at the same time the received priority is transferred to the image quality determination unit 1204 (ID match 1413). In the image quality determination unit 1204, the image quality is determined in accordance with the received priority (image quality determination step 1414). An example of the image quality determination includes a case where a bit rate or a frame rate are increased when the priority is “high”, and the bit rate or the frame rate are lowered when the priority is “low”. At this point, the image pickup is performed in the image pickup unit 102 (image pickup step 1415).

In Accordance with the image quality determined in the image quality determination unit 1204, the image processing unit 1205 performs image processing (image processing step 1416).

Next, it is judged whether or not the transmission is permitted in the transmission judgment unit 104 (transmission permission judgment step 1417). When the IDs match with each other in the ID comparison unit 106, the transmission is permitted. When the transmission is permitted, the ID of the image pickup device (image pickup device 101B), the received ID of the in-vehicle device 108B, and the picked-up image are transmitted from the transmission unit 1206 to the in-vehicle device 108B (image and ID transmission step 1418).

When the reception unit 1207 of the in-vehicle device 108B receives the IDs and the image (image and ID reception step 1405), the received ID of the image pickup device 101B and the ID retrieved in the image pickup device retrieval unit 113 are compared with each other to determine whether or not the IDs match with each other, and the received ID of the in-vehicle device 108B and the ID of the device (in-vehicle device) are compared with each other to determine whether or not the IDs match with each other (ID comparison step 1406). When both of the IDs match with each other, (ID match 1407), the matching IDs are displayed on the display device 111 (display step 1408).

As the display method, the screen division display or the overlap display described in the first embodiment can also be adopted. In addition, as in the second embodiment, the configuration may also be adopted in which the transmission unit for transmitting the positional information, the image pickup direction, and the ID of the device (image pickup device) to the surrounding area is additionally provided in the image pickup device, and the image pickup deice installation information reception unit for receiving the positional information, the image pickup direction, and the ID of the image pickup device that are transmitted by the image pickup device is additionally provided in the in-vehicle device.

### Fourth Embodiment

When real time characteristics are impaired by a reduction in transmission rate between the image pickup device and the in-vehicle device, the possibility of occurrence of accidents is increased, which is extremely dangerous.

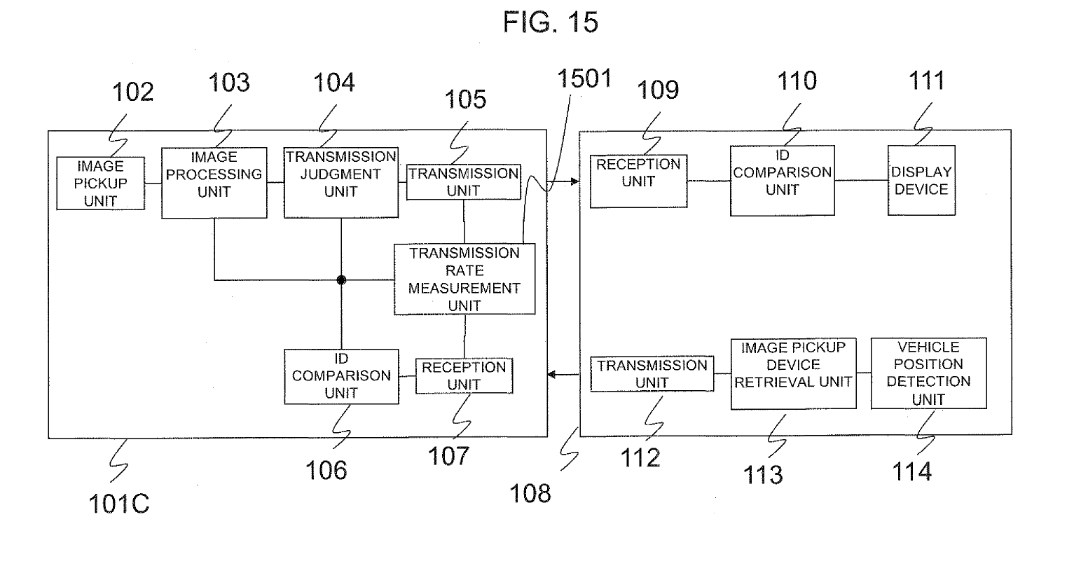

FIG. 15 is a block diagram showing an entire configuration of an intersection situation recognition system in the present fourth embodiment. The entire configuration in FIG. 15 is obtained by adding a transmission rate measurement unit 1501 as a new block to FIG. 1 as the entire configuration of the above-described first embodiment. A device in which the block is newly added to the image pickup device 101 in FIG. 1 is an image pickup device 101C, while the in-vehicle device 108 is the same device as that in FIG. 1.

This embodiment is characterized in that the transmission rate measurement unit 1501 for measuring the transmission rate between the image pickup device 101C and the in-vehicle device 108 is provided in the image pickup device 101C.

When the transmission rate is not less than a specific rate, it is judged that the image data can be transmitted without delay, and a normal process is performed.

When the transmission rate is reduced to be less than the specific rate, it is judged that the transmission of the image data is delayed and real time characteristics are thereby impaired, and the real time characteristics are secured by lowering the image quality to reduce the data size of the image, or reducing the process content in the image pickup device.

When the transmission rate is further reduced, the amount of processing is further reduced by performing both of the image quality adjustment and the process reduction to secure the real time characteristics.

By making stepwise judgment in this manner, it becomes possible to transmit an easily visible image in correspondence to the transmission (transfer) rate to the in-vehicle device while securing the real time characteristics.

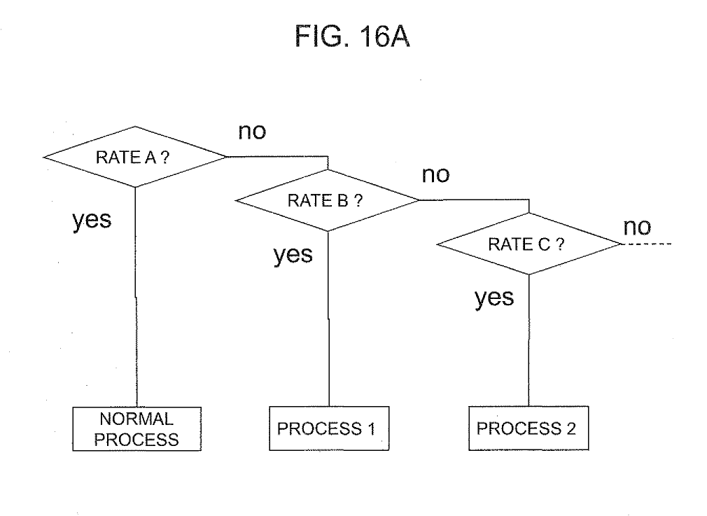

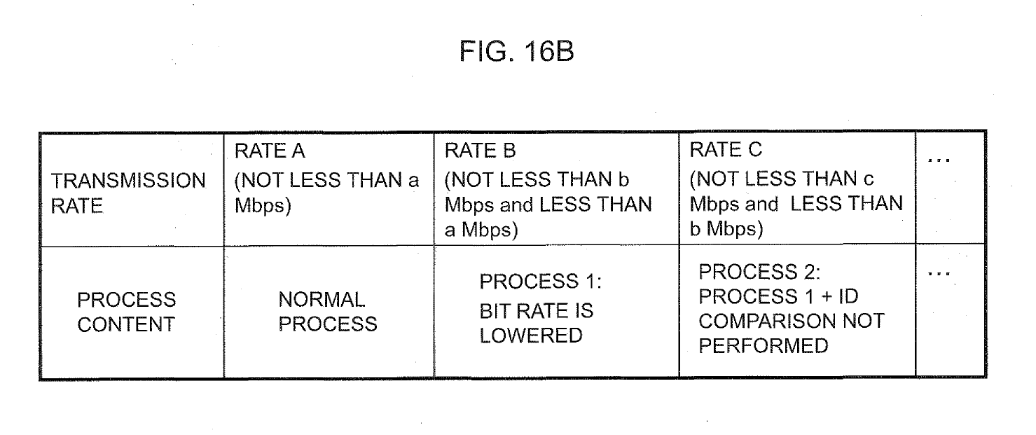

FIG. 16 includes views showing examples of processes performed when the transmission rate is reduced. When the transmission rate measured in the transmission rate measurement unit 1501 is a rate A (not less than a Mbps), it is judged that the transmission rate is adequate, and a normal process is performed (normal process).

When the measured transmission rate is a rate B (not less than b Mbps and less than a Mbps) (b<a), it is judged that the transmission rate is reduced so that the real time characteristics are impaired when the normal process is performed, and a process for lowering the bit rate of the image data is performed (process 1). Although the image quality of the image is reduced by lowering the bit rate, the size of the data to be transmitted is also reduced so that the transmission period can be shortened and the real time characteristics can be secured.

When the transmission rate is further reduced to be a rate C (not less than c Mbps and less than b Mbps) (c<b), and the real time characteristics can be be secured only by performing the process for lowering the bit rate, the ID comparison process in the ID comparison unit 106 and the transmission judgment in the transmission judgment unit 104 are not performed, and a state where the transmission is permitted at any time is maintained (process 2). By reducing the process content in the image pickup device 101C to preferentially perform the transmission process in this manner, the transmission rate is increased, and the real time characteristics are thereby secured.

In the example of FIGS. 16A and 16B, although the processes of three stages are performed, it is also possible to add a process performed when the transmission rate is further reduced. These examples are only illustrative, and therefore the reduction in process content in the image pickup device may be performed first, or it is also possible to change the image size such as reducing the image size from VGA to QVGA in addition to the lowering of the bit rate.

In the fourth embodiment, although the configuration is adopted in which the transmission rate measurement unit is added to the first embodiment, it is also possible to add the transmission rate measurement unit to the second embodiment or the third embodiment, and the same effect as that in the above-described fourth embodiment is obtained in either case.

At this point, when a configuration is adopted in which the image pickup device starts the image pickup after the image pickup device receives the ID and the priority from the in-vehicle device, i.e., the image pickup is performed after the in-vehicle device requests the image, the image pickup device can be adapted not to perform the image pickup while no vehicle passes by so that power consumption can be reduced.

In addition, with regard to installation positions of the image pickup device, if the image pickup device is installed on a post for a convex minor that is actually installed or on the upper portion of the convex mirror, it is not necessary to newly provide a post for the image pickup device. Further, if the image pickup device is installed on a traffic signal, concern over power supply is eliminated.

Furthermore, in a ease where only one image pickup device is installed at an intersection, it is not necessary to use priority information.

Moreover, in a case where the configuration is not adopted in which the image quality is changed by using the priority information, it is not necessary to transmit the in-vehicle device identification number from the in-vehicle device.

### INDUSTRIAL APPLICABILITY

Since the intersection situation can be reliably grasped without entry into the intersection according to the present invention, the present invention can be used at least in a traffic safety system.

### REFERENCE SIGNS LIST

101 image pickup device
102 image pickup unit
103 image processing unit
104 transmission judgment unit
105 transmission unit
106 ID comparison unit
107 reception unit
108 in-vehicle device
109 reception unit
110 ID comparison unit
111 display device
112 transmission unit
113 image pickup device retrieval unit
114 vehicle position detection unit

1. An intersection situation recognition system comprising:
an image pickup device installed in a vicinity of an intersection, and for picking up an image of a direction not visible from a vehicle that is about to enter the intersection and transmitting the picked-up image to the vehicle that is about to enter the intersection; and
an in-vehicle device mounted in the vehicle that is about to enter the intersection, and for receiving and displaying the image from the image pickup device installed in the vicinity of the intersection, wherein
the in-vehicle device has:
a vehicle position detection unit for detecting a position of the vehicle in which the in-vehicle device is mounted and a running direction thereof;
an image pickup device retrieval unit for determining the intersection that the vehicle is about to enter from the position of the vehicle and the running direction thereof detected by the vehicle position detection unit, and retrieving an image pickup device identification number in correspondence to the image pickup device installed in the vicinity of the determined intersection;
an in-vehicle device-side transmission unit for transmitting the image pickup device identification number retrieved by the image pickup device retrieval unit to the image pickup device installed in the vicinity of the intersection;
an in-vehicle device-side reception unit for receiving the image and an image pickup device identification number transmitted from the image pickup device installed in the vicinity of the intersection;
an in-vehicle device-side identification number comparison unit for comparing the image pickup device identification number received by the in-vehicle device-side reception unit with the image pickup device identification number retrieved by the image pickup device retrieval unit, and detecting a match between the image pickup device identification numbers; and
a display device for displaying the image received from the image pickup device in correspondence to the image pickup device identification numbers between which the match is detected by the in-vehicle device-side identification number comparison unit, and
the image pickup device has:
an image pickup device identification number setting unit for setting the unique image pickup device identification number;
an image pickup unit for picking up an image of an intersection situation;
an image pickup device-side reception unit for receiving the image pickup device identification number transmitted from the in-vehicle device mounted in the vehicle that is about to enter the intersection;
an image pickup device-side identification number comparison unit for comparing the image pickup device identification number received by the image pickup device-side reception unit with the unique image pickup device identification number set in the image pickup device, and detecting a match between the image pickup device identification numbers;
a transmission judgment unit for judging whether or not transmission is permitted in accordance with a result of the match detection by the image pickup device-side identification number comparison unit; and
an image pickup device-side transmission unit for transmitting the image picked up by the image pickup unit and the unique image pickup device identification number to the in-vehicle device mounted in the vehicle that is about to enter the intersection when the image pickup device identification numbers match with each other and the transmission judgment unit judges that the transmission is permitted.

2. The intersection situation recognition system according to claim 1, wherein the image pickup device retrieval unit pre-records positional information, an image pickup direction, and the image pickup device identification number of the image pickup device in association with each other.

3. The intersection situation recognition system according to claim 1, wherein
the image pickup device has a transmission unit for transmitting image pickup device installation information including positional information, an image pickup direction, and the image pickup device identification number of the image pickup device to a surrounding area, and
the in-vehicle device has an image pickup device installation information reception unit for receiving the image pickup device installation information including the positional information, the image pickup direction, and the image pickup device identification information of the image pickup device.

4. The intersection situation recognition system according to claim 3, wherein the image pickup device retrieval unit records the positional information, the image pickup direction, and the image pickup device identification number of the image pickup device received by the image pickup device installation information reception unit in association with each other.

5. The intersection situation recognition system according to claim 1, wherein
the in-vehicle device has a priority judgment unit for assigning priorities to a plurality of image pickup devices based on an image pickup direction of the plurality of image pickup devices and the running direction of the vehicle in which the in-vehicle device is mounted in a state where the plurality of image pickup devices are installed at the intersection that the vehicle is about to enter,
the in-vehicle device-side transmission unit transmits the priorities of the plurality of image pickup devices assigned by the priority judgment unit in association with the image pickup device identification number,
the image pickup device-side reception unit receives the priorities of the image pickup devices from the in-vehicle device mounted in the vehicle that is about to enter the intersection, and
the image pickup device further has an image quality determination unit for determining an image quality of the image to be transmitted to the in-vehicle device mounted in the vehicle that is about to enter the intersection in accordance with the priorities of the image pickup devices received by the image pickup device-side reception unit, and an image processing unit for performing image processing on the image picked up by the image pickup unit in accordance with the image quality determined in the image quality determination unit.

6. The intersection situation recognition system according to claim 5, wherein the priority judgment unit assigns the priorities in accordance with route guidance of a route guidance device mounted in the vehicle in which the in-vehicle device is mounted.

7. The intersection situation recognition system according to claim 5, wherein the priority judgment unit assigns the priorities in accordance with a direction of a direction indicator of the vehicle in which the in-vehicle device is mounted.

8. The intersection situation recognition system according to claim 1, wherein
the in-vehicle device has an in-vehicle device identification number setting unit for setting a unique in-vehicle device identification number,
the in-vehicle device-side transmission unit transmits the unique in-vehicle device identification number to the image pickup device installed in the vicinity of the intersection,
the image pickup device-side reception unit receives the in-vehicle device identification number transmitted from the in-vehicle device mounted in the vehicle that is about to enter the intersection,
the image pickup device-side transmission unit transmits the in-vehicle device identification number to the in-vehicle device mounted in the vehicle that is about to enter the intersection,
the in-vehicle device-side reception unit receives the in-vehicle device identification number transmitted from the image pickup device installed in the vicinity of the intersection,
the in-vehicle device-side identification number comparison unit compares the in-vehicle device identification number received by the in-vehicle device-side reception unit with the in-vehicle device identification number unique to the in-vehicle device, and detects a match between the in-vehicle device identification numbers, and
the display device displays the image received from the image pickup device in correspondence to the image pickup device identification numbers between which the match is detected by the in-vehicle device-side identification number comparison unit when the match between the in-vehicle device identification number received by the in-vehicle device-side reception unit and the in-vehicle device identification number unique to the in-vehicle device is detected by the in-vehicle device-side identification number comparison unit.

9. The intersection situation recognition system according to claim 1, wherein the display device displays the received image on an entire screen.

10. The intersection situation recognition system according to claim 1, wherein the display device divides a screen, and displays the received image on a part of the screen and displays another image on a remaining portion of the screen simultaneously with the received image.

11. The intersection situation recognition system according to claim 10, wherein the another image is an image showing route guidance.

12. The intersection situation recognition system according to claim 1, wherein the display device displays route guidance on a screen, and displays the received image on the screen in overlapping relation on the route guidance.

13. The intersection situation recognition system according to claim 1, wherein
the in-vehicle device requests the image pickup device installed in the vicinity of the intersection to pick up an image of the intersection when the vehicle in which the in-vehicle device is mounted is about to enter the intersection, and
the image pickup device performs image pickup only when the request for the image pickup is made from the in-vehicle device mounted in the vehicle that is about to enter the intersection.

14. The intersection situation recognition system according to claim 1, wherein the image pickup device has a transmission rate measurement unit for measuring a transmission rate between the image pickup device and the in-vehicle device, and performs at least one of a change of an image process content, a change of a bit rate of an image, and a change of an image size stepwise in accordance with the transmission rate as a measurement result by the transmission rate measurement unit.

15. An image pickup device installed in a vicinity of an intersection, and for picking up an image of a direction not visible from a vehicle that is about to enter the intersection and transmitting the picked-up image to the vehicle that is about to enter the intersection, comprising:
an image pickup device identification number setting unit for setting a unique image pickup device identification number;
an image pickup unit for picking up an image of an intersection situation;
an image pickup device-side reception unit for receiving an image pickup device identification number transmitted from an in-vehicle device mounted in the vehicle that is about to enter the intersection;
an image pickup device-side identification number comparison unit for comparing the image pickup device identification number received by the image pickup device-side reception unit with the unique image pickup device identification number set in the image pickup device, and detecting a match between the image pickup device identification numbers;
a transmission judgment unit for judging whether or not transmission is permitted in accordance with a result of the match detection by the image pickup device-side identification number comparison unit; and
an image pickup device-side transmission unit for transmitting the image picked up by the image pickup unit and the unique image pickup device identification number to the in-vehicle device mounted in the vehicle that is about to enter the intersection when the image pickup device identification numbers match with each other and the transmission judgment unit judges that the transmission is permitted.

16. The image pickup device according to claim 15, wherein
the image pickup device-side reception unit receives an in-vehicle device identification number transmitted from the in-vehicle device mounted in the vehicle that is about to enter the intersection, and
the image pickup device-side transmission unit transmits the in-vehicle device identification number to the in-vehicle device mounted in the vehicle that is about to enter the intersection.

17. The image pickup device according to claim 15, comprising:
a transmission unit for transmitting image pickup device installation information including positional information, an image pickup direction, and the image pickup device identification number of the image pickup device to a surrounding area.

18. The image pickup device according to claim 15, wherein
the image pickup device-side reception unit receives a priority of the image pickup device from the in-vehicle device mounted in the vehicle that is about to enter the intersection,
the image pickup device further comprising:
an image quality determination unit for determining an image quality of the image to be transmitted to the in-vehicle device mounted in the vehicle that is about to enter the intersection in accordance with the priority of the image pickup device received by the image pickup device-side reception unit; and
an image processing unit for performing image processing on the image picked up by the image pickup unit in accordance with the image quality determined by the image quality determination unit.

19. The image pickup device according to claim 15, wherein the image pickup device performs image pickup only when a request for the image pickup is made from the in-vehicle device mounted in the vehicle that is about to enter the intersection.

20. The image pickup device according to claim 15, further comprising:
a transmission rate measurement unit for measuring a transmission rate between the image pickup device and the in-vehicle device, wherein
at least one of a change of an image process content, a change of a bit rate of an image, and a change of an image size is performed stepwise in accordance with the transmission rate as a measurement result by the transmission rate measurement unit.

21. An in-vehicle device mounted in a vehicle that is about to enter an intersection, and for receiving and displaying an image from an image pickup device installed in a vicinity of the intersection, comprising:
a vehicle position detection unit for detecting a position of the vehicle in which the in-vehicle device is mounted and a running direction thereof;
an image pickup device retrieval unit for determining the intersection that the vehicle is about to enter from the position of the vehicle and the running direction thereof, and retrieving an image pickup device identification number in correspondence to the image pickup device installed in the vicinity of the determined intersection;
an in-vehicle device-side transmission unit for transmitting the image pickup device identification number retrieved by the image pickup device retrieval unit to the image pickup device installed in the vicinity of the intersection;
an in-vehicle device-side reception unit for receiving the image and an image pickup device identification number transmitted from the image pickup device installed in the vicinity of the intersection;
an in-vehicle device-side identification number comparison unit for comparing the image pickup device identification number received by the in-vehicle device-side reception unit with the image pickup device identification number retrieved by the image pickup device retrieval unit, and detecting a match between the image pickup device identification numbers; and
a display device for displaying the image received from the image pickup device in correspondence to the image pickup device identification numbers between which the match is detected by the in-vehicle device-side identification number comparison unit.

22. The in-vehicle device according to claim 21, wherein the image pickup device retrieval unit pre-records positional information, an image pickup direction, and the image pickup device identification number of the image pickup device in association with each other.

23. The in-vehicle device according to claim 21, further comprising:
an image pickup device installation information reception unit for receiving image pickup device installation information including positional information, an image pickup direction, and the image pickup device identification number of the image pickup device.

24. The in-vehicle device according to claim 23, wherein the image pickup device retrieval unit records the positional information, the image pickup direction, and the image pickup device identification number of the image pickup device received by the image pickup device installation information reception unit in association with each other.

25. The in-vehicle device according to claim 22, further comprising:
a priority judgment unit for assigning priorities to a plurality of image pickup devices based on the image pickup direction of the plurality of image pickup devices and the running direction of the vehicle in which the in-vehicle device is mounted in a state where the plurality of image pickup devices are installed at the intersection that the vehicle is about to enter, wherein
the in-vehicle device-side transmission unit transmits the priorities of the plurality of image pickup devices assigned by the priority judgment unit in association with the image pickup device identification number.

26. The in-vehicle device according to claim 25, wherein the priority judgment unit assigns the priorities in accordance with route guidance of a route guidance device mounted in the vehicle in which the in-vehicle device is mounted.

27. The in-vehicle device according to claim 25, wherein the priority judgment unit assigns the priorities in accordance with a direction of a direction indicator of the vehicle in which the in-vehicle device is mounted.

28. The in-vehicle device according to claim 21, further comprising:
an in-vehicle device identification number setting unit for setting a unique in-vehicle device identification number, wherein
the in-vehicle device-side transmission unit transmits the unique in-vehicle device identification number to the image pickup device installed in the vicinity of the intersection,
the in-vehicle device-side reception unit receives the in-vehicle device identification number transmitted from the image pickup device installed in the vicinity of the intersection,
the in-vehicle device-side identification number comparison unit compares the in-vehicle device identification number received by the in-vehicle device-side reception unit with the in-vehicle device identification number unique to the in-vehicle device, and detects a match between the in-vehicle device identification numbers, and
the display device displays the image received from the image pickup device in correspondence to the image pickup device identification numbers between which the match is detected by the in-vehicle device-side identification number comparison unit when the match between the in-vehicle device identification number received by the in-vehicle device-side reception unit and the in-vehicle device identification number unique to the in-vehicle device is detected by the in-vehicle device-side identification number comparison unit.

29. The in-vehicle device according to claim 21, wherein the display device displays the received image on an entire screen.

30. The in-vehicle device according to claim 21, wherein the display device divides a screen, and displays the received image on a part of the screen and displays another image on a remaining portion of the screen simultaneously with the received image.

31. The in-vehicle device according to claim 30, wherein the another image is an image showing route guidance.

32. The in-vehicle device according to claim 21, wherein the display device displays route guidance on a screen, and displays the received image on the screen in overlapping relation on the route guidance.

33. The in-vehicle device according to claim 21, wherein the in-vehicle device requests the image pickup device installed in the vicinity of the intersection to pick up an image of the intersection when the vehicle in which the in-vehicle device is mounted is about to enter the intersection.
